(19) United States
(12) Patent Application Publication
(10) Pub. No.: US 2007/0189367 A1
(43) Pub. Date: Aug. 16, 2007

(54) Method and apparatus for combining of HRPD F-MAC channel in soft/softer handoff region in a mobile communication system

(75) Inventors: Soo-Bok Yeo, Suwon-si (KR); Jong-Han Lim, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/652,973

(22) Filed: Jan. 12, 2007

(30) Foreign Application Priority Data
Jan. 12, 2006 (KR) 2006-3618

(51) Int. Cl. H04B 1/00

(52) U.S. Cl. 375/148

(57) ABSTRACT

Provided is a method and apparatus for efficient combining of a MAC channel in a rake receiver of an HRPD system. The method includes demodulating symbols from fingers to which different MAC indexes (MACIndex) are assigned by different sectors; aligning and discriminating channels transmitted in in-phase and channels transmitted in quadrature-phase by referring to the MAC indexes allocated to users according to sectors; soft-combining the aligned and discriminated symbols according to cells; demultiplexing the soft-combined symbols according to MAC sub-channels; and determining a symbol command for each MAC sub-channel of each cell and performing logical combining of determined symbols.

### PRIORITY

This application claims priority under 35 U.S.C. § 119(a) to an application entitled “Method And Apparatus For Combining Of HRPD F-MAC Channel In Soft/Softer Handoff Region In A Mobile Communication System” filed in the Korean Industrial Property Office on Jan. 12, 2006 and assigned Serial No. 2006-3618, the contents of which are incorporated herein by reference.

### BACKGROUND OF THE INVENTION

1. Field of the Invention

The present invention relates to a rake receiver of a High Rate Packet Data (HRPD) system, and more particularly to a method and an apparatus for efficient combining of a forward Medium Access Control (MAC) channel.

2. Description of the Related Art

A forward MAC (F-MAC) channel of an HRPD system is equal to a Reverse Power Control (RPC) channel. Hereinafter, a detailed description will be given with reference to the accompanying drawings.

FIG. 1 is a block diagram illustrating a structure of a conventional rake receiver. The receiver allocates N number of fingers to one cell and receives signals transmitted from K number of cells. That is, the receiver allocates N number of fingers and has K number of allocated cells.

Received data signals are processed by a receiver input processor 110. A searcher 120 detects multi-path signals from the signals processed by the receiver input processor 110. A microprocessor 130 allocates a finger to each of the multi-path signals. Fingers 135 and 140 of the rake receiver demodulate corresponding detected path signals, respectively. Combiners 165 and 170 combine the demodulated signals according to cells. The symbol determiner 175 determines transmission symbols in consideration of the output signals of the combiners 165 and 170.

The example shown in FIG. 1 is based on the case in which the signal transmitted from a transmitter is a Forward Power Control Sub-Channel (F-PCSCH) signal.

In the case of a CDMA2000 1x system, the F-PCSCH is simultaneously transmitted in both in-phase and quadrature-phase, and the same symbol is transmitted for each phase.

Therefore, in a conventional mobile communication system, a cell symbol combiner performs soft combining of symbols while identifying an F-PCSCH for each cell. Thereafter, the symbols combined for each cell are input to the symbol determiner 175, which determines an F-PCSCH symbol for each cell and performs logical combining of different cells.

In a conventional CDMA 2000 1x system as described above, multiple sectors constituting one cell in a softer handoff region transmit the same F-PCSCH symbol. Therefore, a receiver can perform symbol determination by performing soft combining without discriminating between the in-phase and quadrature-phase signals.

However, due to the introduction of the HRPD system, technologies are being developed to transmit different information at different phases by transmission signals. Therefore, such development of technologies requires a change in the structure of the receiver.

### SUMMARY OF THE INVENTION

Accordingly, the present invention has been made to solve the above-mentioned problems occurring in the prior art, and an object of the present invention is to provide a method and apparatus for efficient combining of a MAC channel in a rake receiver of an HRPD system.

In a rake receiver in HRPD system according to the present invention, for efficient combining of the MAC channel, fingers exchange in-phase signals and quadrature-phase signals according to a MAC index for each sector, thereby performing combining of signals output from fingers allocated to the same sector simultaneously with the soft-combining of the sectors. Therefore, the present invention provides a method and an apparatus, which can improve hardware efficiency, can omit the symbol combiner for each sector from the hardware, and can replace the sub-channel demultiplexing logic for each sector with the sub-channel demultiplexing logic for each cell.

In order to accomplish this and other objects, there is provided a method for combining of a High Rate Packet Data (HRPD) Forward Medium Access Control (F-MAC) channel in a handoff region, the method including demodulating symbols from fingers to which different MAC indexes (MACIndex) are assigned by different sectors; aligning and discriminating channels transmitted in in-phase and channels transmitted in quadrature-phase by referring to the MAC indexes allocated to users according to sectors; soft-combining the aligned and discriminated symbols according to cells; demultiplexing the soft-combined symbols according to MAC sub-channels; and determining a symbol command for each MAC sub-channel of each cell and performing logical combining of determined symbols.

In accordance with another aspect of the present invention, there is provided an apparatus for combining of a High Rate Packet Data (HRPD) Forward Medium Access Control (F-MAC) channel in a handoff region, the apparatus including a receiver input processor for receiving and processing a signal transmitted from a transmitter; a searcher for detecting a multi-path signal from the received signal and outputting detected multi-path information; a microprocessor for receiving the detected multi-path information, allocating paths to fingers based on the detected multi-path information, and controlling symbols by referring to forward MAC indexes; finger symbol demodulators for demodulating symbols from fingers to which different MAC indexes (MACIndex) are assigned by different sectors; an in-phase/quadrature-phase exchanger for aligning and discriminating channels transmitted in in-phase and channels transmitted in quadrature-phase by referring to the MAC indexes allocated to users according to sectors; symbol combiners for soft-combining the aligned and discriminated symbols according to cells; sub-channel demultiplexers for demultiplexing the soft-combined symbols according to MAC sub-channels; and a sub-channel symbol determiner for determining a symbol command for each MAC sub-channel of each cell and performing logical combining of determined symbols.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a conventional rake receiver;

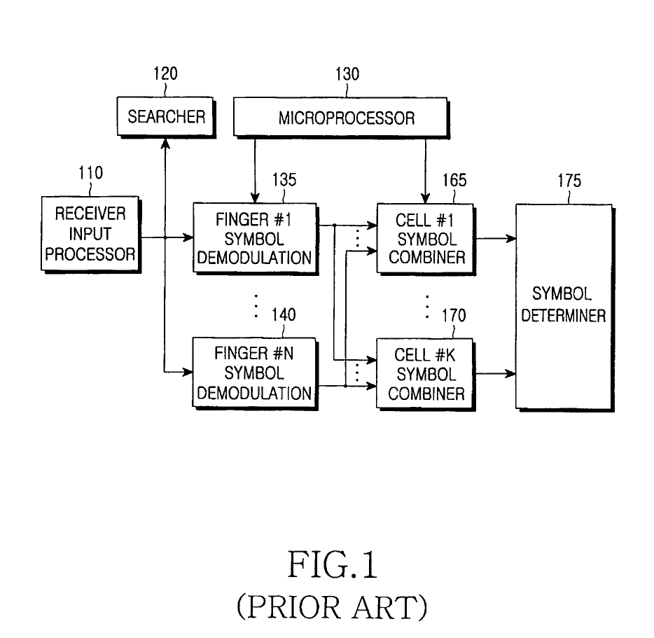

FIG. 2 is a block diagram illustrating a structure of a forward MAC channel receiver according to the first embodiment of the present invention;

FIG. 3 is a block diagram illustrating a structure of a forward MAC channel receiver according to the second embodiment of the present invention; and

FIG. 4 is a flow diagram of a process for receiving a forward MAC channel according to the second embodiment of the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention rather unclear. Further, various specific definitions found in the following description are provided only to help general understanding of the present invention, and it is apparent to those skilled in the art that the present invention can be implemented without such definitions.

In an HRPD system, a forward MAC channel is a channel transmitted in each slot after the call set-up.

The forward MAC channel, which is used to transmit information generated in the MAC layer, does not transmit message information but transmits bit information. Further, when it is transmitted, the forward MAC channel is Code Division Multiplexed (CDM) between users, instead of being Time Division Multiplexed (TDM) between users as is the Forward Traffic Channel (FTC).

At this time, a code for each user is determined from a MACIndex given to each user. The MACIndex is a parameter included in a Traffic Channel Assignment Message (TCAM). Table 1 shows Walsh codes for users according to the MACIndex, which can be used in the forward MAC channel.

TABLE 1

| | Rev. 0 (Subtype 0, 1) | | | Rev. A (Subtype 2) | | |
|---|---|---|---|---|---|---|
| | MAC Channel Use | | Walsh Index | MAC Channel Use | | Walsh Index |
| MACIndex i | I-Phase | Q-Phase | Assignment | I-Phase | Q-Phase | Assignment |
| 0, 1, 2, 3 | N/A | N/A | N/A | N/A | N/A | N/A |
| 4 | RA | N/A | 2 | RA | N/A | 2 |
| 5 | N/A | RPC, | (i − 1)/ | N/A | N/A | N/A |
| | | DRCLock | 2 + 32 | | | |
| 6, 8, . . . , 62 | RPC, | N/A | i/2 | RPC, | DRCLock, | i/2 |
| | DRClock | | | H/L-ARQ | P-ARQ | |
| 7, 9, . . . , 63 | N/A | RPC, | (i − 1)/ | DRCLock, | RPC, | (i − 1/ |
| | | DRCLock | 2 + 32 | P-ARQ | H/L-ARQ | 2 + 32 |
| 64, 65, . . . , 7i | N/A | N/A | N/A | N/A | N/A | N/A |
| 72, 74, . . . , 126 | N/A | N/A | N/A | RPC, | DRCLock, | i/2 + 32 |
| | | | | H/L-ARQ | P-ARQ | |
| 73, 75, . . . , 127 | N/A | N/A | N/A | DRCLock, | RPC, | (i − 1)/ |
| | | | | P-ARQ | H/L-ARQ | 2 + 64 |

In Table 1, N/A is an abbreviation of “Not Available,” which implies that something is not available in the forward MAC channel. Further, the Walsh code has a length of 64 in Rev.0 and 128 in Rev.A.

The forward MAC channel can be divided into sub-channels of Reverse Power Control (RPC), Data Rate Control Lock (DRCLock), Reverse Activity (RA), and Automatic Repeat reQuest (ARQ) only for the Rev.A, and is transmitted after being modulated by a Binary Phase Shift Keying (BPSK) scheme.

The receiver transmits the ARQ to the transmitter upon receiving erroneous data, and the transmitter retransmits the erroneous block.

The RPC is used in order to transmit a Power Control Bit (PCB) for the reverse traffic channel and control channel.

The DRCLock is used when an Access Point (AP) transmits information if it is normally receiving reverse Data Rate Control (DRC) channel data to an Access Terminal (AT).

The RA is a control channel used to transfer information by which an AP informs an AT of a loading degree of the uplink, and the AT uses the RA bit in determining the data rate of the reverse traffic channel.

The RA channel is a shared channel transmitted to multiple users within one sector, and is transmitted in in-phase always using a Walsh code having an index of 2. The RA channel does not perform soft-combining in a softer handoff region, because the RA channel carries different information according to sectors.

The MAC sub-channels other than the RA channel are dedicated channels for each user, and use Walsh codes determined by the MACIndex.

Further, when the other sub-channels other than the RA channel are BPSK modulated, as noted from Table 1, it is possible to recognize if each sub-channel is transmitted in in-phase or quadrature-phase, by determining if the MACIndex is an even number or an odd number.

It is required for it to be possible to soft-combine and demodulate the forward MAC channels excluding the RA channel, because the same information can be transmitted from multiple sectors within a softer handoff region. At this time, MACIndexes allocated to ATs in each sector may have different values.

Therefore, because the same MAC sub-channel may be transmitted in in-phase within one sector while being transmitted in quadrature-phase within another sector, they must be properly differentiated in soft-combining of them. In the case of multiple sectors, the forward MAC sub-channel carries different information in the in-phase and the quadrature-phase.

Because the forward MAC channel can be transmitted not only from multiple sectors but also from multiple cells, it is necessary to identify the forward MAC channel for each cell in demodulating the forward MAC channel. In general, multiple sectors included in the same cell transmit the same forward MAC channel symbol, and different cells transmit different forward MAC channel symbols having different information.

Therefore, in a forward MAC channel receiver, a forward MAC channel symbol transmitted from one cell is determined by soft-combining forward MAC channels with the same symbol transmitted from sectors within the same cell, and the forward MAC channel symbols according to cells are then subjected to logical-combining, thereby determining the forward MAC channel symbol value. Exceptionally, for the DRCLock channel, only the symbol determination for each cell may be performed without performing logical combining.

In the handoff region of the HRPD system as described above, whether to perform the soft combining is determined by the “softer Handoff” parameter of the Route Update Protocol (RUP).

From among the forward MAC sub-channels as described above, the RA channel is a shared channel, which uses a fixed MACIndex (=4) instead of being identified by the MACIndex for each user and is not soft-combined within a softer handoff region. Therefore, the present invention does not consider the RA channel and provides an efficient hardware structure for reception of the RPC, DRCLock, and ARQ (Hybrid/Last/Packet) channels, which are dedicated channels for users, from among the forward MAC sub-channels.

### FIRST EMBODIMENT

According to the first embodiment of the present invention, it is necessary to perform the following steps in order to demodulate a forward MAC channel in a soft/softer handoff region.

1) First, from among the signals received by fingers allocated to the same sector, in-phase signals are combined with each other, and quadrature-phase signals are combined with each other.

2) It is determined if a specific sub-channel is transmitted in the in-phase or the quadrature-phase, with reference to the MACIndex, (that is, by using the Least Significant Bit (LSB) value of the MACIndex having seven bits,) and the sub-channel is then demultiplexed according to transmission time points of time-multiplexed sub-channels.

3) Next, incoming signals of different sectors carrying the same symbol and inter-sector symbols are soft-combined.

4) The inter-sector soft-combined symbol is considered as a signal received from a single cell. Symbols are determined for the cells, and are then logically combined, to determine a final forward MAC channel symbol. Exceptionally, for the DRCLock channel, only symbol determination for each cell can be performed without logical combining.

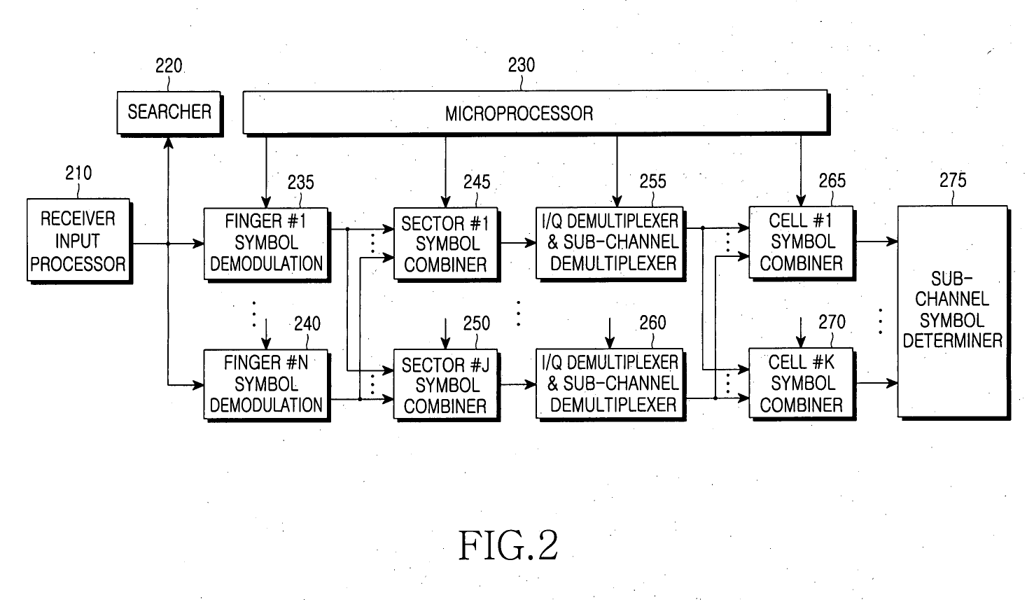

FIG. 2 is a block diagram illustrating a structure of a forward MAC channel receiver according to the first embodiment of the present invention.

Referring to FIG. 2, the receiver allocates N number of fingers, J number of sectors, and K number of cells.

A receiver input processor 210 includes a receiver antenna, an RF reception module, and an Analog to Digital Converter (ADC), which are usually used in a digital wireless communication terminal. Further, the receiver input processor 210 may include a filter, an interpolator, etc. A searcher 220 detects a multi-path signal from an incoming signal output from the receiver input processor 210, and the detected multi-path information is transferred to a microprocessor 230, which allocates the fingers.

The fingers 235 and 240 of the rake receiver demodulate signals of the detected paths. This is a typical method used by a wireless communication terminal employing a typical rake receiver.

Thereafter, a signal from each finger is transferred to the sector symbol combiners 245 and 250 for sectors. Then, the sector symbol combiners 245 and 250 combine in-phase signals in in-phase signals and quadrature-phase signals in quadrature-phase signals from among the signals received by the fingers allocated to the same sector, and outputs the combined signals to the I/Q demultiplexer & sub-channel demultiplexers 255 and 260.

The I/Q demultiplexer & sub-channel demultiplexers 255 and 260 determine if a particular sub-channel is transmitted in in-phase or quadrature-phase, by referring to the MACIndex under the control of the microprocessor 230, and then demultiplexes the sub-channel according to transmission time points of the time-multiplexed sub-channels.

The demultiplexed information is processed for each cell in such a manner that the symbol combiners 265 and 270 soft-combine the incoming signals of different sectors carrying the same symbol and inter-sector symbols and transfer the soft-combined signals to a sub-channel symbol determiner 275. The sub-channel symbol determiner 275 deals with the inter-sector soft-combined signal as a signal received from one cell, and determines a final forward MAC channel symbol by determining and logically combining the symbols according to cells.

As described above, in order to implement the first embodiment of the present invention, the forward MAC channel receiver additionally includes the symbol combiners 245 and 250 for each sector, the sub-channel demultiplexers logic 255 and 260 for each sector, and symbol combiners 265 and 275 for each cell.

### SECOND EMBODIMENT

According to the second embodiment of the present invention, fingers exchange the in-phase/quadrature-phase signals according to the MACIndex for each sector, thereby performing combining of signals output from fingers allocated to the same sector simultaneously with the soft-combining of the sectors. As a result, it is possible to improve hardware efficiency, omit the symbol combiner for each sector from the hardware, and replace the sub-channel demultiplexer for each sector by a sub-channel demultiplexer for each cell.

According to the present embodiment, the maximum number of cells to be supported by the HRPD is six, and there is no definition for the number of sector. However, the number of cells to be supported by the HRPD is smaller than the number of cells usually supported.

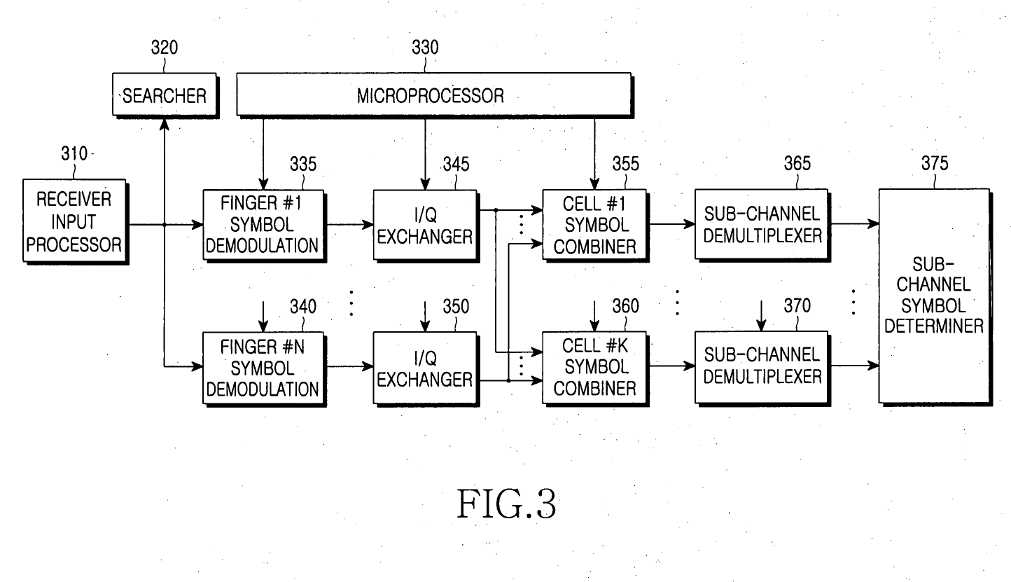

FIG. 3 is a block diagram illustrating a structure of a forward MAC channel receiver according to the second embodiment of the present invention.

Referring to FIG. 3, the receiver allocates N number of fingers and K number of cells. A searcher 320 detects a multi-path signal from an incoming signal output from a receiver input processor 310, and the detected multi-path information is transferred to a microprocessor 330, which allocates the fingers. The fingers 335 and 340 of the rake receiver demodulate signals of the detected paths.

Thereafter, signals from the fingers are divided and aligned into in-phase channel signals and quadrature-phase channel signals, so as to allow exchange of the in-phase signals and quadrature-phase signals. Whether to exchange the in-phase signals and quadrature-phase signals is determined with reference to the MACIndex allocated to each finger.

For example, the I/Q exchange is performed when the LSB of the MACIndex having seven bits has a value of 1, while the I/Q exchange is not performed when the LSB of the MACIndex having seven bits has a value of 0. In contrast, the I/Q exchange may be performed when the LSB of the MACIndex having seven bits has a value of 0, while the I/Q exchange is not performed when the LSB of the MACIndex having seven bits has a value of 1.

The outputs of the I/Q exchangers 345 and 350 are combined by the symbol combiners 355 and 360 for each cell, and the microprocessor 330 controls the cell or sector allocation information of each finger, thereby determining whether to combine the finger outputs. Thereafter, the soft-combined symbols for each cell are discriminated according to the RPC, DRCLock, H/L/P-ARQ channels by the sub-channel demultiplexers 365 and 370, and are then input to a sub-channel symbol determiner 375.

The sub-channel symbol determiner 375 determines symbols according to the cells, and performs logical combining of them, thereby determining a final forward MAC channel symbol.

In the symbol determination, for example, the RPC channel transmits a power up command and a power down command. Specifically, whether to transmit a power up command or a power down command is first determined for each cell. When only a single down command is included, then the final RPC command is determined to be the power down command. Otherwise, it is determined to be the power up command.

For another example, the ARQ channel determines a positive-acknowledgement (ACK) or a negative-acknowledgement (NACK) for a Reverse Traffic Channel (RTC) packet of each cell. It determines ACK when a single ACK is included. Otherwise, it determines NACK. For another example, the DRCLock channel can determine a DRCLock symbol for each cell instead of performing logical combining for each cell.

The above-described operation of the microprocessor 330 can be performed by other suitable devices (for example, a Digital Signal Processor (DSP)), and the operation of sub-channel determination can also be performed by any other suitable device.

Each MAC sub-channel is time-multiplexed for each slot (each slot corresponds to a time interval of 1.667 ms) for transmission, and the sub-channel demultiplexer logic identifies the RPC, DRCLock, and ARQ channels by using the transmission timing information of each MAC sub-channel.

That is, in the case of Rev.0, the RPC and DRCLock channels are received from one phase signal from among the in-phase or the quadrature-phase signals according to the MACIndex, and sub-channel demultiplexing is performed for a corresponding single phase.

Meanwhile, in the case of Rev.A, demultiplexing is performed by receiving the RPC and H/L-ARQ channels from one phase signal from among the in-phase or the quadrature-phase signals according to the MACIndex, and by receiving the DRCLock and P-ARQ channels from the other phase signal.

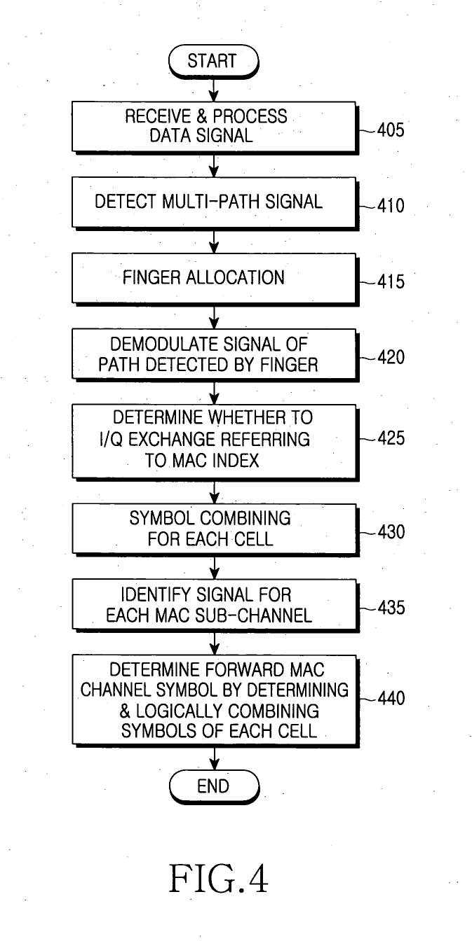

FIG. 4 is a flow diagram of a process for receiving a forward MAC channel according to the second embodiment of the present invention.

Referring to FIG. 4, in step 405, the receiver receives and processes a data signal. In step 410, the searcher detects a multi-path signal. Then, in step 415, the detected multi-path information is transferred to the microprocessor for allocation of fingers.

In step 420, each of the fingers demodulates the detected path signal. The demodulated signal is transferred to the I/Q exchanger, which determines whether to exchange the signal by referring to the MACIndex allocated to each finger in step 425. Because the channel transmitted in the in-phase and the channel transmitted in the quadrature-phase are different from each other according to the allocated MACIndex, the signal exchanges and arranges the I/Q with reference to the MACIndex. The output of the I/Q exchanger is transferred to the symbol combiner for each cell, which combines the symbols of the cells in step 430. Then, in step 435, the combined symbols of the cells are discriminated according to the RPC, DRCLock, and H/L/P-ARQ channels by the sub-channel demultiplexer.

In step 440, the demultiplexed signals according to the channels are input to the sub-channel symbol determiner, which then determines the symbol for each cell and logically combines the symbols, thereby determining the final forward MAC channel symbol.

According to the present invention as described above, it is possible to obtain the effects as briefly described below.

According to the present invention, a rake receiver includes an I/Q exchanger, so that it can soft-combine signals transmitted with different MACIndexes from different sectors in a softer handoff region.

In view of the output of the I/Q exchanger and each finger of a rake receiver in an HRPD system, in the case of Rev.0 according to an embodiment of the present invention, the in-phase output may be the RPC or DRCLock symbols, and the quadrature-phase output does not exist. Further, in the case of Rev.A, the in-phase output may be the RPC or H/L-ARQ symbols, and the quadrature-phase may be the DRCLock or P-ARQ symbols. Further, the in-phase and quadrature-phase forward MAC sub-channels may be symbols opposite to those described above.

By using the I/Q exchanger, it is possible to omit the symbol combiner for each sector, thereby improving hardware efficiency. Further, according to the present invention, it is possible to implement the demultiplexing logic for each sector by using a smaller number of sub-channel demultiplexers according to sub-channels, thereby improving hardware efficiency.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for combining of a High Rate Packet Data (HRPD) Forward Medium Access Control (F-MAC) channel in a handoff region, the method comprising the steps of:
(1) demodulating symbols from fingers to which different MAC indexes (MACIndex) are assigned by different sectors;
(2) aligning and discriminating channels transmitted in in-phase and channels transmitted in quadrature-phase by referring to the MAC indexes allocated to users according to sectors;
(3) soft-combining the aligned and discriminated symbols according to cells;
(4) demultiplexing the soft-combined symbols according to MAC sub-channels; and
(5) determining a symbol command for each MAC sub-channel of each cell and performing logical combining of determined symbols.

2. The method as claimed in claim 1, wherein, in step (2), referring to the MAC indexes includes determining whether to perform exchange between in-phase signals and quadrature-phase signals, by using a least significant bit of the MAC index having seven bits.

3. The method as claimed in claim 1, wherein, in step (3), a Reverse Power Control (RPC) channel and a Data Rate Control Lock (DRCLock) channel are received from only a single phase signal from among the in-phase signals and the quadrature-phase signals, and sub-channel demultiplexing is performed for only a single corresponding phase.

4. The method as claimed in claim 1, wherein, in step (3), demultiplexing is performed by receiving an RPC channel and a Hybrid/Last-ARQ (H/L-ARQ) channel from one phase signal from among the in-phase or the quadrature-phase signals, and by receiving the DRCLock channel and Packet-ARQ (P-ARQ) channel from the other phase signal from among the in-phase or the quadrature-phase signals.

5. An apparatus for combining of a High Rate Packet Data (HRPD) Forward Medium Access Control (F-MAC) channel in a handoff region, the apparatus comprising:
a receiver input processor for receiving and processing a signal transmitted from a transmitter;
a searcher for detecting a multi-path signal from the received signal and outputting detected multi-path information;
a microprocessor for receiving the detected multi-path information, allocating paths to fingers based on the detected multi-path information, and controlling symbols by referring to forward MAC indexes;
finger symbol demodulators for demodulating symbols from fingers to which different MAC indexes (MACIndex) are assigned by different sectors;
an in-phase/quadrature-phase exchanger for aligning and discriminating channels transmitted in in-phase and channels transmitted in quadrature-phase by referring to the MAC indexes allocated to users according to sectors;
symbol combiners for soft-combining the aligned and discriminated symbols according to cells;
sub-channer demultiplexers for demultiplexing the soft-combined symbols according to MAC sub-channels; and
a sub-channel symbol determiner for determining a symbol command for each MAC sub-channel of each cell and performing logical combining of determined symbols.

6. The apparatus as claimed in claim 5, wherein referring to the MAC indexes by the microprocessor includes determining whether to perform exchange between in-phase signals and quadrature-phase signals, by using a least significant bit of the MAC index having seven bits.

7. The apparatus as claimed in claim 5, wherein the sub-channel demultiplexers receive a Reverse Power Control (RPC) channel and a Data Rate Control Lock (DRCLock) channel from only a single phase signal from among the in-phase signals and the quadrature-phase signals, and perform sub-channel demultiplexing for only a single corresponding phase.

8. The apparatus as claimed in claim 5, wherein the sub-channel demultiplexers perform demultiplexing by receiving an RPC channel and a Hybrid/Last-ARQ (H/L-ARQ) channel from one phase signal from among the in-phase or the quadrature-phase signals, and perform demultiplexing by receiving the DRCLock channel and Packet-ARQ (P-ARQ) channel from the other phase signal from among the in-phase or the quadrature-phase signals.
